(19) United States
(12) Patent Application Publication
(10) Pub. No.: US 2023/0035540 A1
(43) Pub. Date: Feb. 2, 2023

(54) HOLDING DEVICE AND MANUFACTURING METHOD OF STATOR

(71) Applicant: TOYOTA JIDOSHA KABUSHIKI KAISHA, Toyota-shi (JP)

(72) Inventors: Yuki MORI, Toyota-shi (JP); Kotaro SUZUKI, Nisshin-shi (JP)

(73) Assignee: TOYOTA JIDOSHA KABUSHIKI KAISHA, Toyota-shi (JP)

(21) Appl. No.: 17/811,663

(22) Filed: Jul. 11, 2022

(30) Foreign Application Priority Data
Jul. 30, 2021 (JP) 2021-125776

(51) Int. Cl. H02K 15/06; H02K 15/10

(52) U.S. Cl. CPC H02K 15/066; H02K 15/105

(57) ABSTRACT

Provided is a holding device usable when a stator is machined, the stator including a toric stator core, a plurality of coils (see FIG. 1) provided such that coil ends of the coils project from both ends of the stator core in its axial direction, and insulating paper disposed between the stator core and each of the coils. The holding device includes: a core fixture configured to fix the stator core; and a coil-end fixing portion configured to fix to-be-machined coil ends such that the coil-end fixing portion presses the to-be-machined coil ends from the inner side to the outer side in the radial direction of the stator core. A relative position in the axial direction between the stator core fixed by the core fixture and the to-be-machined coil ends fixed by the coil-end fixing portion is fixed.

### CROSS-REFERENCE TO RELATED APPLICATION

This application claims priority to Japanese Patent Application No. 2021-125776 filed on Jul. 30, 2021, incorporated herein by reference in its entirety.

### BACKGROUND

### 1. Technical Field

The present disclosure relates to a holding device and a manufacturing method of a stator.

### 2. Description of Related Art

Japanese Unexamined Patent Application Publication No. 2014-233164 (JP 2014-233164 A) describes a holding device including individual holders for fixing coils to a stator core at the time when a stator is formed by disposing the coils and insulating paper in respective slots of the stator core. Note that the holding device is a holding device including as many individual holders as the coils.

### SUMMARY

In the holding device described in JP 2014-233164 A, a hold blade is brought into contact with a coil disposed in a slot of the stator core, so that the coil is fixed to the stator core.

Here, FIG. 13 is a view of the stator core viewed from its axial direction and illustrates a state where the hold blade interferes with insulating paper disposed in the slot at the time when the hold blade is moved from the inner side toward the outer side in the radial direction of the stator core. That is, FIG. 13 is a view illustrating a problem in the holding device described in JP 2014-233164 A. As illustrated in FIG. 13, insulating paper via which the stator core is insulated from the coil is disposed inside the slot of the stator core. Accordingly, in a case where the hold blade is inserted into the slot from the inner side toward the outer side in the radial direction, the hold blade might interfere with the insulating paper.

In view of this, when coil ends as parts where coils project from an axial end of the stator core are fixed by a fixture, it is possible to restrain interference of the fixture with insulating paper. However, in a case where the coil ends are fixed just by using the fixture, a plurality of coils can be fixed mutually, but the stator coil is not fixed to the coils. This accordingly causes such a problem that, when axial force is applied to the coil ends in a manufacturing process of the stator, the stator core and the coils move relative to each other in the axial direction of the stator core.

The present disclosure is accomplished in view of such a circumstance and provides a holding device for fixing a stator core to coils with a simple configuration and a manufacturing method of a stator.

A holding device according to the present disclosure is a holding device usable when a stator is machined. The stator includes a toric stator core, a plurality of coils provided such that coil ends of the coils project from both ends of the stator core in the axial direction of the stator core, and insulating paper disposed between the stator core and each of the coils. The holding device includes a core fixture and a coil-end fixing portion. The core fixture is configured to fix the stator core. The coil-end fixing portion is configured to fix to-be-machined coil ends among the coil ends by pressing the to-be-machined coil ends from the inner side toward the outer side in the radial direction of the stator core. A relative position in the axial direction between the stator core fixed by the core fixture and the to-be-machined coil ends fixed by the coil-end fixing portion is fixed.

Further, a manufacturing method of a stator according to the present disclosure is a manufacturing method for manufacturing a stator including a toric stator core, a plurality of coils provided such that coil ends of the coils project from both ends of the stator core in the axial direction of the stator core, and insulating paper disposed between the stator core and each of the coils. The manufacturing method includes: a step of fixing to-be-machined coil ends by pressing the to-be-machined coil ends from the inner side toward the outer side in the radial direction of the stator core; a step of fixing a relative position between the stator core and the to-be-machined coil ends in the axial direction of the stator core; and a step of machining the to-be-machined coil ends fixed by pressing.

Hereby, by pressing coil ends of coils targeted for machining, the coils can be fixed.

Hereby, it is possible to provide a holding device for fixing a stator core to coils with a simple configuration and a manufacturing method of a stator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a configuration of a stator 1;

FIG. 2 is an example of a top view illustrating the stator 1 in which a first holding device 10 is disposed;

FIG. 3 is a sectional view illustrating a configuration of a coil-end fixing portion 12 when the coil-end fixing portion 12 is viewed from the circumferential direction of the stator 1;

FIG. 4A is a sectional view illustrating an example of fixing parts where coil ends 31 are fixed by the coil-end fixing portions 12 when the fixing parts are viewed from the circumferential direction;

FIG. 4B is a sectional view illustrating an example of the fixing parts where the coil ends 31 are fixed by the coil-end fixing portions 12 when the fixing parts are viewed from the circumferential direction;

FIG. 4C is a sectional view illustrating an example of the fixing parts where the coil ends 31 are fixed by the coil-end fixing portions 12 when the fixing parts are viewed from the circumferential direction;

FIG. 5 is a perspective view illustrating a coil-end fixing portion 21 of a second holding device 20;

FIG. 6 is a top view illustrating the second holding device 20 in which a plurality of coil-end fixing portions 21 is disposed in an annular manner;

FIG. 7 is a view illustrating an example of a process of manufacturing the stator 1;

FIG. 8A is a sectional view illustrating an example of expansion molding of the coil end 31 when the coil end 31 is viewed from the circumferential direction;

FIG. 8B is a sectional view illustrating an example of the expansion molding of the coil end 31 when the coil end 31 is viewed from the circumferential direction;

FIG. 9A is a sectional view illustrating the operation of the first holding device 10 in the expansion molding when the first holding device 10 is viewed from the circumferential direction;

FIG. 9B is a sectional view illustrating the operation of the first holding device 10 in the expansion molding when the first holding device 10 is viewed from the circumferential direction;

FIG. 9C is a sectional view illustrating the operation of the first holding device 10 in the expansion molding when the first holding device 10 is viewed from the circumferential direction;

FIG. 9D is a sectional view illustrating the operation of the first holding device 10 in the expansion molding when the first holding device 10 is viewed from the circumferential direction;

FIG. 9E is a sectional view illustrating the operation of the first holding device 10 in the expansion molding when the first holding device 10 is viewed from the circumferential direction;

FIG. 10A is a view illustrating the operation of tilt molding;

FIG. 10B is a view illustrating the operation of the tilt molding;

FIG. 10C is a view illustrating the operation of the tilt molding;

FIG. 10D is a view illustrating the operation of the tilt molding;

FIG. 11 is a sectional view illustrating a state where a machining device 51 for the tilt molding is disposed;

FIG. 12 is a sectional view illustrating an example of distal-end bending molding; and

FIG. 13 is a view of a stator core viewed from its axial direction and illustrates a state where a hold blade interferes with insulating paper disposed in a slot at the time when the hold blade is operated from the inner side toward the outer side in the radial direction of the stator core.

### DETAILED DESCRIPTION OF EMBODIMENTS

### First Embodiment

Configuration of Stator

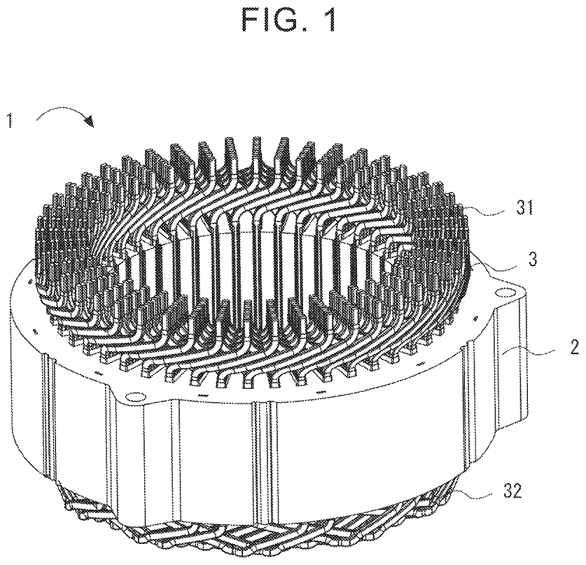

With reference to the drawings, the following describes a holding device and a manufacturing method of a stator according to an embodiment of the present disclosure. First, with reference to FIG. 1, the following describes the holding device according to the first embodiment and a stator to be manufactured by the manufacturing method according to the first embodiment. FIG. 1 is a perspective view illustrating a configuration of the stator. As illustrated in FIG. 1, the stator 1 is formed to include a toric stator core 2, a plurality of coils 3 provided such that coil ends 31, 32 of the coils 3 project from both ends of the stator core 2 in its axial direction, and insulating paper (not illustrated) disposed between the stator core 2 and each of the coils 3.

Typically, the stator core 2 is formed such circular thin iron plates are put on top of each other. Further, a plurality of slots is provided on the inner surface of the stator core 2. The slots are formed on the inner side of the stator core 2 at predetermined intervals in the circumferential direction of the stator core 2, and each of the slots has a groove shape extending in the axial direction of the stator core 2. Further, the coils 3 provided in multiple layers in the radial direction of the stator core 2 are inserted into each of the slots.

In the following description, the axial direction of the stator core 2 may be described as an up-down direction. Further, the axial direction of the stator core 2, the circumferential direction of the stator core 2, and the radial direction of the stator core 2 may be just referred to as the axial direction, the circumferential direction, and the radial direction, respectively.

The coils 3 partially project upward from an upper end portion of the stator core 2 in the axial direction. Also, the coils 3 partially project downward from a lower end portion of the stator core 2 in the axial direction. A part of the coil 3 that projects upward is referred to as an upper coil end 31, and a part of the coil 3 that projects downward is referred to as a lower coil end 32.

The coil ends 31, 32 are disposed in multiple layers in the radial direction of the stator core 2 and are disposed continuously in the circumferential direction of the stator core 2 in a state where they are distanced from each other only by a predetermined distance.

Note that the upper coil ends 31 projecting upward are coil ends on a lead side. In the meantime, the lower coil ends 32 projecting downward are coil ends on an opposite lead side.

Here, the multiple layers can be six layers or eight layers, but the number of layers is not limited to this. The following description deals with a case of six layers. Further, the upper coil ends 31 of the coils 3 disposed in a predetermined single slot are referred to as upper coil ends 31a, 31b, 31c, 31d, 31e, 31f sequentially from the inner side in the radial direction. This also applies to the lower coil ends 32.

Configuration of Holding Device

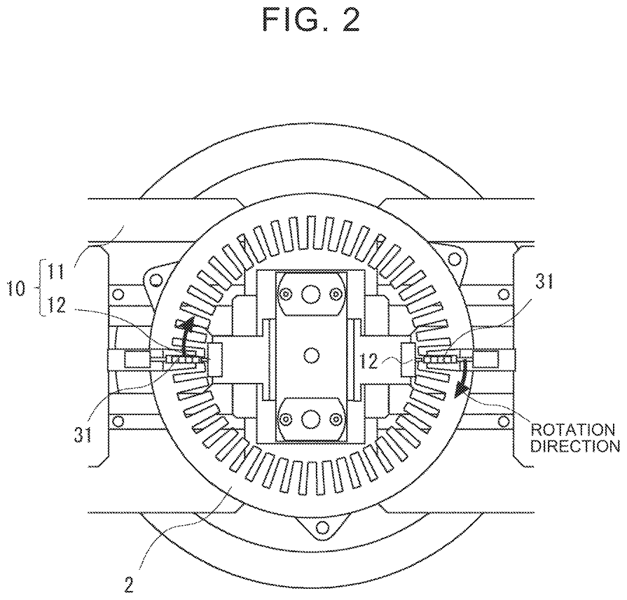

With reference to FIGS. 2 to 6, the following describes a holding device (a first holding device 10 and a second holding device 20) according to the first embodiment.

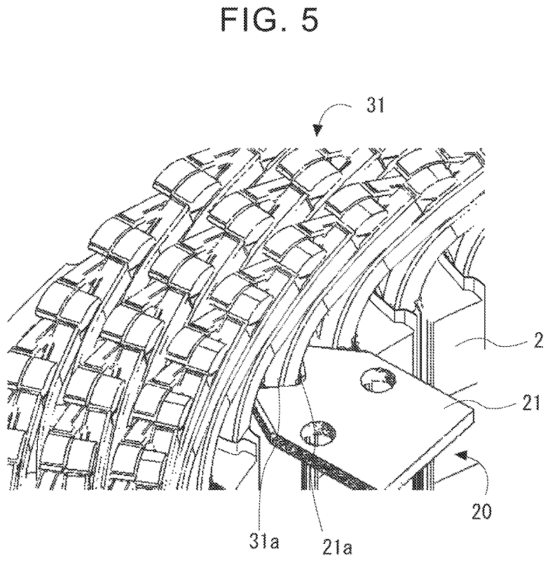

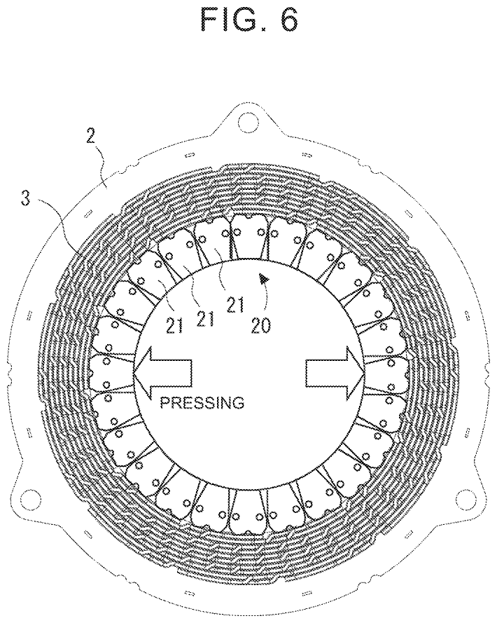

As will be described later in detail, each of the first holding device 10 illustrated in FIGS. 2 to 4C, for example, and the second holding device 20 illustrated in FIGS. 5, 6, for example, is a device having a function to press at least one of the coil ends 31, 32 disposed in both ends (see FIG. 1) from the inner side toward the outer side in the radial direction.

Note that, in the following description, coil ends to be targeted for machining are the upper coil ends 31 unless otherwise specified.

First Holding Device 10

First, with reference to FIGS. 2 to 4C, the first holding device 10 will be described. FIG. 2 is an example of a top view illustrating the stator 1 in which the first holding device 10 is disposed. As illustrated in FIG. 2, the first holding device 10 includes a core fixture 11 configured to fix the stator core 2 and a coil-end fixing portion 12 configured to fix the coil ends 31.

As illustrated in FIG. 2, in the first holding device 10, two coil-end fixing portions 12 face each other via the central axis of the toric stator core 2, and the two coil-end fixing portions 12 are disposed at positions where the two coil-end fixing portions 12 can press the coil ends 31. That is, the two coil-end fixing portions 12 are disposed on a diagonal line via the central axis of the stator core.

The core fixture 11 is connected to the stator core 2 and fixes the position of the stator core 2. For example, the core fixture 11 can fix the stator core 2 by abutting with an outside-diameter side surface of the stator core 2, but a fixation method is not limited to this. Further, as will be described later, the core fixture 11 is connected to the two coil-end fixing portions 12.

Here, the following describes one of the two coil-end fixing portions 12 provided on the diagonal line in the first holding device 10. Note that the other one of the two coil-end fixing portions 12 also has a similar configuration.

The coil-end fixing portion 12 fixes at least either of the upper coil ends 31 and the lower coil ends 32 in the coils 3.

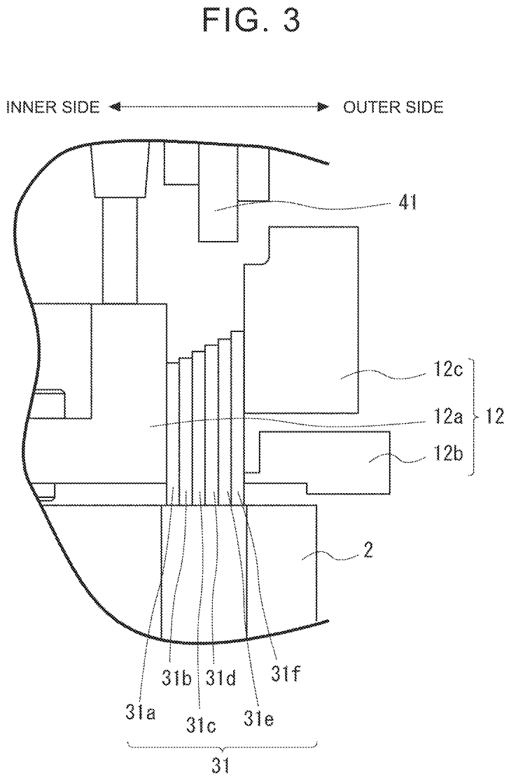

FIG. 3 is a view illustrating a configuration of the coil-end fixing portion 12 when the coil-end fixing portion 12 is viewed from the circumferential direction. As illustrated in FIG. 3, the coil-end fixing portion 12 includes an inner guide clamp 12a disposed on the inner side in the radial direction of the stator core 2, an outer clamp 12b disposed on the outer side in the radial direction, and an outer guide 12c disposed on the outer side in the radial direction.

The inner guide clamp 12a is disposed inwardly from the upper coil ends 31 in the radial direction. Further, the inner guide clamp 12a is movable in the radial direction. Note that, in a case where the inner guide clamp 12a moves outwardly, the inner guide clamp 12a abuts with the upper coil end 31a disposed on the innermost side among the upper coil ends 31.

Further, the inner guide clamp 12a is formed to have a predetermined length in the axial direction. In a case where the inner guide clamp 12a moves outwardly, the inner guide clamp 12a is brought into a state where the inner guide clamp 12a abuts with the upper coil end 31a over a long length in the up-down direction, so that the inner guide clamp 12a can guide an inner-side position of the upper coil end 31a.

Typically, the inner guide clamp 12a strongly presses the upper coil end 31a from the inner side toward the outer side such that axial deviation does not occur.

The outer clamp 12b is disposed outwardly from the upper coil ends 31 in the radial direction. Further, the outer clamp 12b is movable in the radial direction. In a case where the outer clamp 12b moves inwardly, the outer clamp 12b abuts with the upper coil end 31f disposed on the outermost side among the upper coil ends 31.

Typically, the outer clamp 12b strongly presses the upper coil end 31f from the outer side toward the inner side such that axial deviation does not occur.

Further, the outer clamp 12b is placed outwardly from the upper coil ends 31 such that the outer clamp 12b fixes a part of the upper coil end 31f that is close to an upper end surface of the stator core 2, that is, the root of the upper coil end 31f.

Accordingly, the inner guide clamp 12a and the outer clamp 12b strongly press the coil ends 31a to 31f in directions facing each other in a sandwiching manner. Hereby, the inner guide clamp 12a and the outer clamp 12b can fix the coil ends 31a to 31f.

The outer guide 12c is disposed outwardly from the upper coil ends 31 in the radial direction and is also disposed upward from the outer clamp 12b. That is, the outer guide 12c is disposed on a side closer to the distal ends of the coil ends 31 than the outer clamp 12b.

Further, the outer guide 12c is movable in the radial direction. In a case where the outer guide 12c moves inwardly, the outer guide 12c abuts with the upper coil end 31f disposed on the outermost side among the upper coil ends 31.

Note that the outer guide 12c is formed to have a predetermined length in the axial direction. In a case where the outer guide 12c moves inwardly, the outer guide 12c is brought into a state where the outer guide 12c abuts with the upper coil end 31f over a long length in the up-down direction, so that the outer guide 12c can guide an outer-side position of the upper coil end 31f.

Now refer back to FIG. 2. The core fixture 11 configured to fix the stator core 2 is connected to the two coil-end fixing portions 12.

More specifically, the core fixture 11 and the coil-end fixing portions 12 are provided as an integrated member. The core fixture 11 can fix the stator core 2, and the coil-end fixing portions 12 can fix the coil ends 31, 32.

Accordingly, the first holding device 10 can fix a relative position of the coil ends 31, 32 to the stator core 2 in the axial direction. Accordingly, even in a case where axial force is applied to the upper coil ends 31, it is possible to restrain the stator core 2 and the upper coil ends 31 from deviating from each other in the axial direction.

Note that, as one example, the coil-end fixing portion 12 may include a clamp base portion and may be configured such that the inner guide clamp 12a, the outer clamp 12b, and the outer guide 12c are connected to the clamp base portion movably in the radial direction. In this case, when the clamp base portion is fixed to the core fixture 11, it is possible to restrain the stator core 2 and the upper coil ends 31 from deviating from each other in the axial direction.

Further, as illustrated in FIG. 2, in the first holding device 10, the two coil-end fixing portions 12 face each other via the central axis of the toric stator core 2 and are disposed at positions where the two coil-end fixing portions 12 can press their corresponding coil ends 31. That is, the two coil-end fixing portions 12 are disposed on a diagonal line via the central axis of the stator core.

In the first holding device 10, while the two coil-end fixing portions 12 are disposed to face each other, the two coil-end fixing portions 12 rotationally move in the circumferential direction of the stator core 2, so that the two coil-end fixing portions 12 can press and fix the coil ends 31 sequentially.

Note that a power source (not illustrated) may be disposed in the first holding device 10 such that the power source generates power to move the two coil-end fixing portions 12 in the circumferential direction at the same time.

Hereby, after machining is performed on respective coil ends 31 held by the two coil-end fixing portions 12, the two coil-end fixing portions 12 can release the respective coil ends 31 thus machined and then move in the circumferential direction so as to hold subsequent coil ends 31 adjacent to the respective coil ends 31 thus machined. For example, in FIG. 2, the two coil-end fixing portions 12 can move in the clockwise direction at the same time to change their positions.

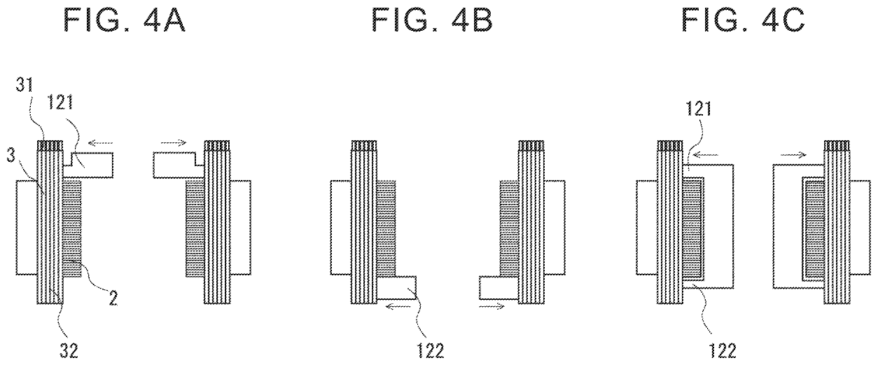

Here, FIGS. 4A, 4B, 4C are sectional views each illustrating an example of fixing parts where the coil ends are fixed by the coil-end fixing portions 12 when the fixing parts are viewed from the circumferential direction. As illustrated in FIGS. 4A, 4B, 4C, the coil-end fixing portions 12 can each have a structure including at least either one of an upper-coil-end fixing portion 121 and a lower-coil-end fixing portion 122. The upper-coil-end fixing portion 121 is configured to fix the upper coil ends 31 as illustrated in FIG. 4A in a case where the upper coil ends 31 are targeted for machining, and the lower-coil-end fixing portion 122 is configured to fix the lower coil ends 32 as illustrated in FIG. 4B in a case where the lower coil ends 32 are targeted for machining.

Further, the coil-end fixing portions 12 can be configured to include both the upper-coil-end fixing portion 121 and the lower-coil-end fixing portion 122 as illustrated in FIG. 4C.

Second Holding Device 20

Next, with reference to FIGS. 5, 6, the second holding device 20 will be described. As illustrated in FIGS. 5, 6, the second holding device 20 includes a core fixture (not illustrated) configured to fix the stator core 2, and a plurality of coil-end fixing portions 21 formed to be thin in the axial direction. Here, FIG. 5 is a perspective view illustrating the coil-end fixing portion 21 provided in the second holding device 20. Note that, in FIG. 5, only one coil-end fixing portion 21 is illustrated from among the coil-end fixing portions 21. Further, FIG. 6 is a top view illustrating the second holding device 20 in which the coil-end fixing portions 21 are disposed in an annular manner.

The core fixture is connected to the stator core 2 and fixes the position of the stator core 2. For example, the core fixture fixes the stator core 2 by abutting with the inner peripheral surface of the stator core 2, but a fixation method is not limited to this. Further, the core fixture is connected to the coil-end fixing portions 21.

The coil-end fixing portion 21 has a groove 21a formed on a radially outer side of the coil-end fixing portion 21 and generally in the center of the coil-end fixing portion 21 in the circumferential direction. The groove 21a is recessed in the radial direction. The coil end 31 is inserted into the groove 21a.

Further, as illustrated in FIG. 6, in the second holding device 20, the coil-end fixing portions 21 each having the groove 21a are provided inwardly from the coil ends 31 in the radial direction such that the coil-end fixing portions 21 are disposed in an annular manner.

The coil-end fixing portions 21 are movable in the radial direction. Further, typically, the coil-end fixing portions 21 move at the same time. Accordingly, the coil-end fixing portions 21 disposed in an annular manner can press the coil ends 31 provided continuously in the circumferential direction from the inner side toward the outer side at the same time.

Further, the core fixture configured to fix the stator core 2 is connected to the coil-end fixing portion 21 configured to fix the coil ends 31. Hereby, relative positions between the stator core 2 and the coil ends 31 are fixed.

Here, particularly, relative positions between the stator core 2 and the coil ends 31 in the axial direction are fixed.

Manufacturing Method of Stator

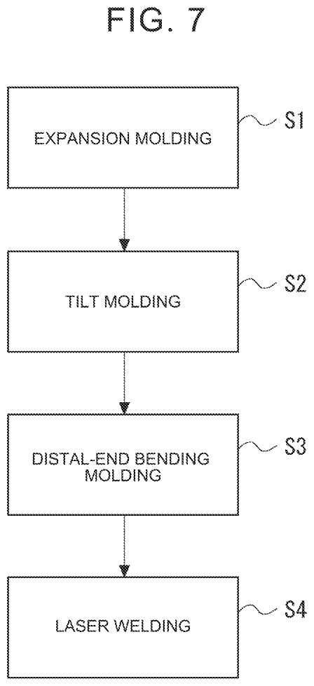

With reference to FIG. 7, the following describes a process of machining the coils 3 disposed in the stator core 2, that is, a manufacturing method of a stator. FIG. 7 is a view illustrating an example of a process of manufacturing the stator. As illustrated in FIG. 7, in the process of machining the coils 3, expansion molding is performed on the coil ends 31 (step S1), tilt molding is performed (step S2), distal-end bending molding is performed (step S3), and laser welding of the coil ends 31 is performed (step S4).

Note that the first holding device 10 is used in step S1 in which expansion molding is performed on the coil ends 31. Further, the second holding device 20 is used in step S2 in which tilt molding is performed on the coil ends 31. The following describes more details of each of steps S1 to S4.

First, expansion molding is performed on the coils 3 (step S1). This step is a molding step to secure an insulation distance between pairs of coil ends in the radial direction among the coil ends 31 of the coils 3 disposed in multiple layers.

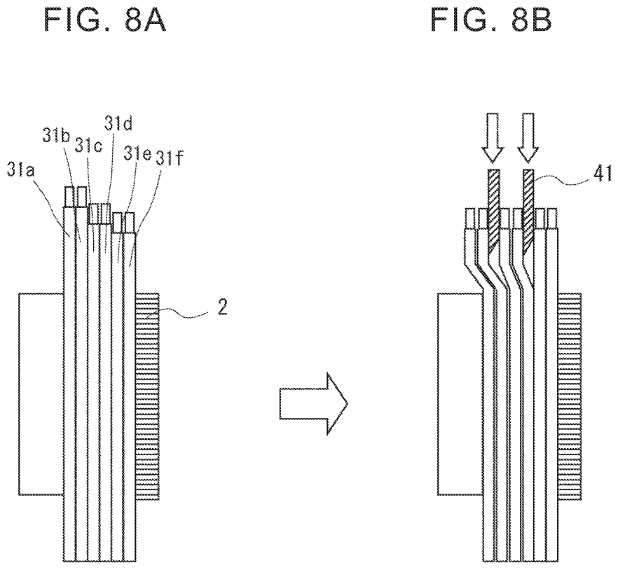

Here, FIGS. 8A, 8B are sectional views each illustrating an example of the expansion molding of the coil ends 31 when the coil ends 31 are viewed from the circumferential direction. The pairs of coil ends indicate a pair of the upper coil ends 31a, 31b, a pair of the upper coil ends 31c, 31d, and a pair of the upper coil ends 31e, 31f, as illustrated in FIG. 8A.

That is, as illustrated in FIG. 8B, the expansion molding is molding to secure an insulation distance between the pairs of coil ends by moving down expansion jigs (forming blades) 41 such that the expansion jigs 41 are inserted between the pair of the upper coil ends 31a, 31b and the pair of the upper coil ends 31c, 31d and between the pair of the upper coil ends 31c, 31d and the pair of the upper coil ends 31e, 31f.

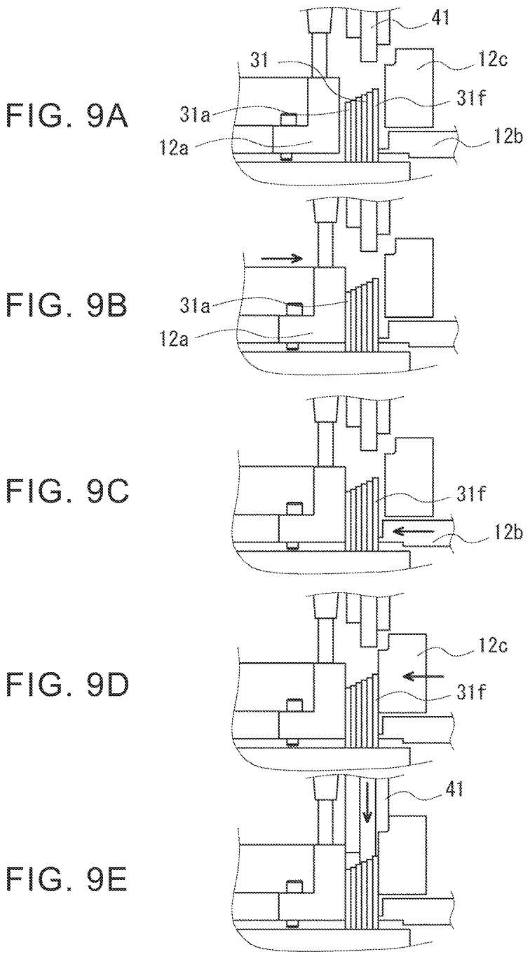

Next will be described, with reference to FIGS. 9A to 9E, a procedure for performing the expansion molding (step S1) while the upper coil ends 31 are fixed by the coil-end fixing portion 12 provided in the first holding device 10, more specifically. FIGS. 9A to 9E are sectional views each illustrating the operation of the first holding device in the expansion molding when the first holding device is viewed from the circumferential direction.

As illustrated in FIG. 9A, the coil-end fixing portion 12 is provided at a position where the coil ends 31 of the coils 3 as a workpiece can be fixed. At this time, the forming blade 41 is disposed above the coil ends 31.

Then, as illustrated in FIG. 9B, the inner guide clamp 12a is moved outwardly in the radial direction. Hereby, the inner guide clamp 12a abuts with the inner surface of the upper coil end 31a disposed on the inner side among the upper coil ends 31. Hereby, the inner guide clamp 12a fixes the inner side of the upper coil ends 31 in the radial direction and also guides the upper coil ends 31 such that the upper coil ends 31 are not bent inwardly by a predetermined amount or more.

Subsequently, as illustrated in FIG. 9C, the outer clamp 12b is moved inwardly in the radial direction. Hereby, the outer clamp 12b abuts with the outer surface of the upper coil end 31f disposed on the outer side among the upper coil ends 31. Hereby, the outer clamp 12b fixes the outer side of the upper coil ends 31 in the radial direction.

Subsequently, as illustrated in FIG. 9D, the outer guide 12c is moved inwardly in the radial direction. Hereby, the outer guide 12c abuts with the outer surface of the upper coil end 31f disposed on the outer side among the upper coil ends 31. Here, the outer guide 12c abuts with the upper coil end 31f on a side closer to its distal end than the outer clamp 12b. Hereby, the outer guide 12c guides the upper coil ends 31 from the outer side in the radial direction such that the upper coil ends 31 are not bent outwardly by a predetermined amount or more.

Subsequently, as illustrated in FIG. 9E, the forming blade 41 is moved down. At this time, the upper coil ends 31 are guided by the inner guide clamp 12a and the outer guide 12c, and therefore, it is possible to keep the upper coil ends 31 in a state where they are not expanded by a predetermined amount or more and to secure an insulation distance between the pairs of coil ends.

At this time, at the time when the forming blade 41 is moved down and inserted between the upper coil ends 31, axially downward force is applied to the upper coil ends 31.

Here, the stator core 2 is fixed by the core fixture 11, and the coil-end fixing portion 12 including the inner guide clamp 12a, the outer clamp 12b, and the outer guide 12c is fixed in a state where the coil-end fixing portion 12 does not move relative to the core fixture 11 in the axial direction. This accordingly restrains occurrence of axial deviation between the stator core 2 and the upper coil ends 31 held by the coil-end fixing portion 12.

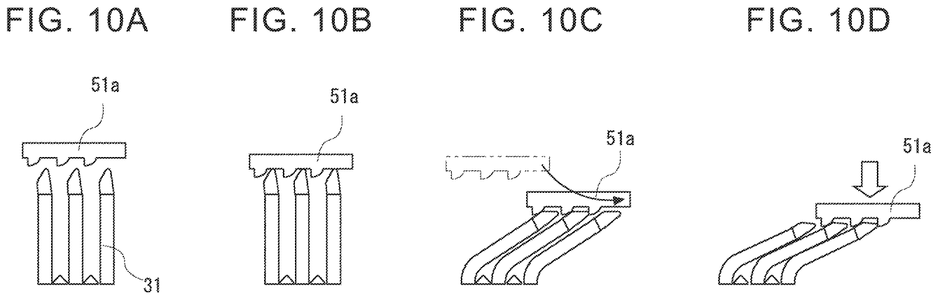

Subsequently, as illustrated in FIG. 7, tilt molding (step S2) is performed. Here, FIGS. 10A to 10D are views each illustrating the operation of the tilt molding. As illustrated in FIGS. 10A to 10D, in the tilt molding, the upper coil ends 31 are tilted by bending in the circumferential direction.

First, as illustrated in FIG. 10A, a tilt machining jig 51a is disposed above the upper coil ends 31.

At this time, as illustrated in FIG. 6, the coil-end fixing portions 21 in the second holding device 20 are disposed inwardly in the radial direction from the upper coil ends 31a such that the coil-end fixing portions 21 are arranged in an annular manner. When the coil-end fixing portions 21 are moved radially outwardly, respective grooves 21a of the coil-end fixing portions 21 radially outwardly abut with their corresponding upper coil ends 31a that the coil-end fixing portions 21 face, and the coil-end fixing portions 21 press and fix the corresponding upper coil ends 31a.

Here, in the second holding device 20, the core fixture configured to fix the stator core 2 is connected to the coil-end fixing portions 21 configured to fix the coil ends 31, so that relative positions between the stator core 2 and the coil ends 31 are fixed.

Note that the coil-end fixing portion 21 presses and fixes a root part of the upper coil end 31a that is close to the stator core 2.

Subsequently, as illustrated in FIG. 10B, the tilt machining jig 51a is brought into contact with the distal ends of the upper coil ends 31.

Then, as illustrated in FIG. 10C, the tilt machining jig 51a is moved down while the tilt machining jig 51a is rotated in the circumferential direction. Hereby, the upper coil ends 31 are tilted. Note that, typically, the tilt machining jig 51a changes holding positions of the upper coil ends 31 at this time.

Subsequently, as illustrated in FIG. 10D, the tilt machining jig 51a pushes the upper coil ends 31 downward. Hereby, the upper coil ends 31 are tilted deeply.

Here, the coil ends 31 before the tilt molding extend linearly in the axial direction. However, the coil ends 31 after the tilt molding can be tilted such that the coil ends 31 are bended in the circumferential direction to reach respective slots distanced from their original slots by 2.5 slots, for example.

Note that even-number layers and odd-number layers of the coil ends 31 formed in multiple layers in the radial direction are bent in directions reverse to each other along the circumferential direction.

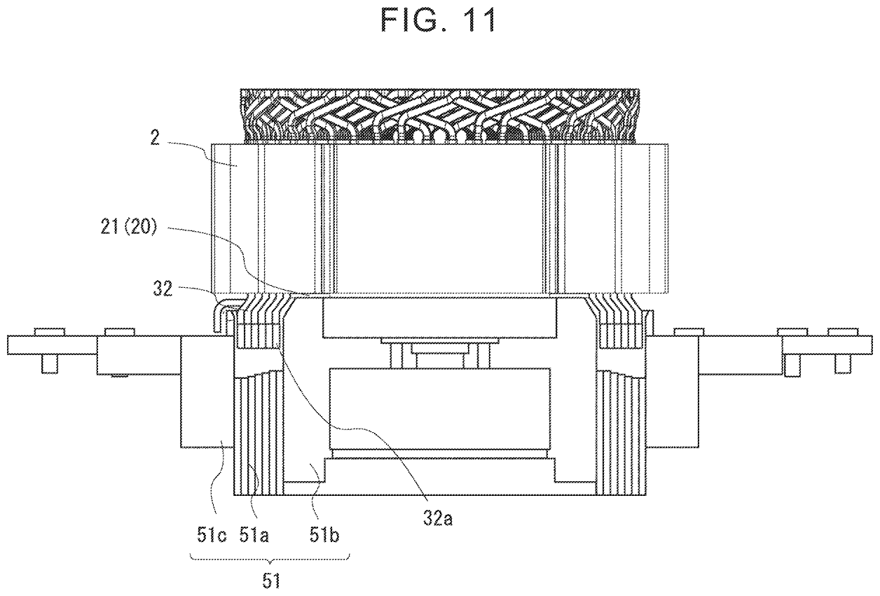

Next will be described a concrete example of the tilt molding with reference to FIG. 11. FIG. 11 is a sectional view illustrating a state where a machining device for tilt molding is disposed. In the example illustrated in FIG. 11, a machining device 51 is used. The machining device 51 includes an inside-diameter guide 51b, an outside-diameter guide 51c, and crown-shaped tilt machining jigs 51a provided in multiple layers in the radial direction between the inside-diameter guide 51b and the outside-diameter guide 51c. Here, as illustrated in FIG. 11, the lower coil ends 32 are subjected to the tilt molding, but this also applies to a case where the upper coil ends 31 are subjected to the tilt molding.

The inside-diameter guide 51b is disposed inwardly in the radial direction from the lower coil ends 32 and abuts with the inner side of the lower coil ends 32. Hereby, the inside-diameter guide 51b guides inward bending of the lower coil ends 32.

The outside-diameter guide 51c is disposed outwardly in the radial direction from the lower coil ends 32 and abuts with the outer side of the lower coil ends 32. Hereby, the outside-diameter guide 51c guides outward bending of the lower coil ends 32.

Here, the machining device 51 is disposed at a position where the inside-diameter guide 51b faces the end surface of the stator core 2 in the axial direction via a gap of about 5 mm, for example.

That is, the coil-end fixing portions 21 are disposed in an annular manner in the gap via which the inside-diameter guide 51b faces the stator core 2.

When the coil-end fixing portions 21 are moved outwardly in the radial direction, the coil-end fixing portions 21 can press and fix respective lower coil ends 32a that the coil-end fixing portions 21 face.

At this time, in the second holding device 20, the core fixture configured to fix the stator core 2 is connected to the coil-end fixing portions 21 configured to fix the coil ends 32, so that relative positions between the stator core 2 and the coil ends 32 are fixed.

Accordingly, at the time of performing the tilt molding on the coil ends 31, 32 by use of the machining device 51, the second holding device 20 is disposed between the inside-diameter guide 51b of the machining device 51 and the stator core 2, so that the tilt molding can be performed by pressing the coil ends 31, 32 by the coil-end fixing portions 21.

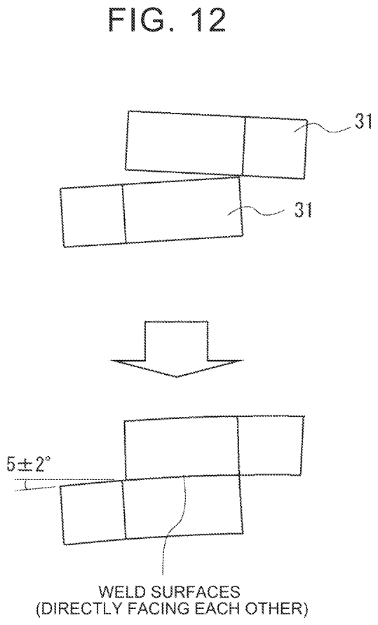

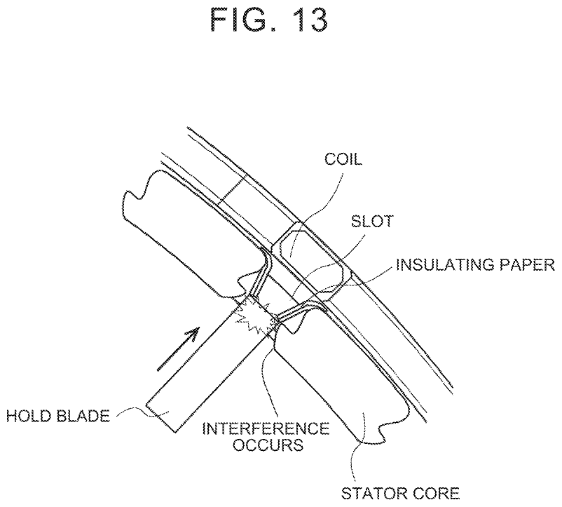

Then, distal-end bending molding (step S3) of the coil ends 31 is performed. Here, FIG. 12 is a sectional view illustrating an example of the distal-end bending molding. As illustrated in FIG. 12, after the tilt molding, weld surfaces of distal ends of the coil ends 31 as a pair of the coil ends targeted for welding form a V-shape. On that account, bending machining is performed such that the weld surfaces directly face each other.

Then, welding machining (step S4) of the coil end 31 is performed. That is, in a state where the coil ends 31 in different layers are tilted to deviate from each other in the circumferential direction in the tilt step, welding machining is performed on the coil ends 31 facing each other in the radial direction by the distal-end bending molding. This welding can be performed by use of a laser beam or the like.

Thus, machining to manufacture the stator 1 can be performed while the stator core 2 and the coil ends 31, 32 of the coils 3 are fixed by use of the first holding device 10 and the second holding device 20.

More specifically, in the expansion molding as one of the steps for manufacturing the stator 1, the coils 3 can be fixed by pressing the coil ends 31, 32 by use of the first holding device 10 having a simple configuration. That is, since a holding device having a complicated configuration is not required, it is possible to reduce the manufacturing cost.

Here, since a positional relationship between the core fixture 11 configured to fix the stator core 2 and the coil-end fixing portions 12 configured to fix the coil ends 31, 32 is fixed, it is possible to fix the positions of the stator core 2 and the coils 3 in the axial direction. Accordingly, even in a case where force is applied to the coil ends 31, 32 such that their positions in the axial direction are changed, it is possible to restrain the coil ends 31, 32 from deviating from the stator core 2 in the axial direction.

Further, the first holding device 10 holds only two coil ends disposed to face each other via the central axis among the coil ends 31, 32 disposed continuously in the circumferential direction. On that account, it is not necessary that the first holding device 10 have a structure by which the first holding device 10 holds all the coil ends 31, 32 disposed in the circumferential direction at the same time, so that the number of the coil-end fixing portions 12 can be reduced, thereby making it the possible to reduce the cost.

Further, similarly, in the tilt molding step, the coils 3 can be fixed by pressing the coil ends 31, 32 by use of the second holding device 20.

Further, the coil-end fixing portions 21 used in the second holding device 20 have a simple configuration in which the coil-end fixing portions 21 fix the coil ends 31, 32 by pressing in a state where the grooves 21a of the coil-end fixing portions 21 abut with the coil ends 31, 32. Accordingly, it is not necessary that the coil-end fixing portions 21 have a complicated configuration, thereby making it possible to achieve a cost reduction.

Note that the present disclosure is not limited to the above embodiment, and various modifications can be made within a range that does not deviate from the gist of the present disclosure. That is, in the above description, omission and simplification are made appropriately for the clarification of the description, and a person skilled in the art can easily change, add, or convert each element in the embodiment within the scope of the present disclosure.

For example, in the first holding device 10, after machining is performed on the coil ends 31, the two coil-end fixing portions 12 disposed on the diagonal line move to hold subsequent coil ends 31 clockwise adjacent to the machined coil ends 31 in a top view. However, the first holding device 10 is not limited to this.

That is, the two coil-end fixing portions 12 may rotate counterclockwise in a top view. Further, the two coil-end fixing portions 12 may fix coil ends other than the coil ends 31 adjacent to the machined coil ends 31. Further, instead of moving the two coil-end fixing portions 12 in the circumferential direction, the stator core 2 may be rotated in the circumferential direction such that the positions of the coil ends 31 are set to face the two coil-end fixing portions 12.

Further, the number of the coil-end fixing portions 12 provided in the first holding device 10 is not limited to two and can be changed to any number.

Further, the above description about the first holding device 10 and the second holding device 20 particularly focus on a point that the coil ends 31, 32 are fixed to the stator core 2 in the axial direction, but the coil ends 31, 32 are also fixable in the circumferential direction or in the radial direction.

What is claimed is:

1. A holding device usable when a stator is machined, the stator including a toric stator core, a plurality of coils provided such that coil ends of the coils project from both ends of the stator core in an axial direction of the stator core, and insulating paper disposed between the stator core and each of the coils, the holding device comprising:
a core fixture configured to fix the stator core; and
a coil-end fixing portion configured to fix to-be-machined coil ends among the coil ends by pressing the to-be-machined coil ends from an inner side toward an outer side in a radial direction of the stator core, wherein a relative position in the axial direction between the stator core fixed by the core fixture and the to-be-machined coil ends fixed by the coil-end fixing portion is fixed.

2. The holding device according to claim 1, wherein:
the to-be-machined coil ends are disposed in multiple layers in the radial direction; and
the coil-end fixing portion includes
an inner guide clamp configured to fix an innermost coil end among the to-be-machined coil ends disposed in the multiple layers by pressing the innermost coil end from the inner side toward the outer side, the inner guide clamp being configured to guide bending of the to-be-machined coil ends from the inner side when machining is performed on the to-be-machined coil ends,
an outer clamp configured to fix an outermost coil end among the to-be-machined coil ends disposed in the multiple layers by pressing the outermost coil end from the outer side toward the inner side, and
an outer guide configured to abut with the outermost coil end among the to-be-machined coil ends disposed in the multiple layers and guide the bending of the to-be-machined coil ends from the outer side when the machining is performed on the to-be-machined coil ends.

3. The holding device according to claim 1, wherein:
the coil-end fixing portion includes only two coil-end fixing portions placed such that the two coil-end fixing portions face each other via a central axis of the stator core; and
the two coil-end fixing portions rotationally move in a circumferential direction of the stator core such that the two coil-end fixing portions sequentially press and fix corresponding coil ends.

4. The holding device according to claim 1, wherein:
the coil ends are disposed in multiple layers in the radial direction;
the coil-end fixing portion includes coil-end fixing portions having respective grooves into each of which a corresponding one of the coil ends is insertable, the respective grooves being formed on respective outer sides, in the radial direction of the stator core, of the coil-end fixing portions;
the coil-end fixing portions are disposed inwardly in the radial direction from the coil ends such that the coil-end fixing portions are continuously arranged in a circumferential direction of the stator core;
the coil-end fixing portions face respective innermost coil ends from among the coil ends disposed in the multiple layers; and
the coil-end fixing portions fix the respective innermost coil ends that the coil-end fixing portions face by pressing the respective innermost coil ends from the inner side toward the outer side in the radial direction.

5. A manufacturing method for manufacturing a stator including a toric stator core, a plurality of coils provided such that coil ends of the coils project from both ends of the stator core in an axial direction of the stator core, and insulating paper disposed between the stator core and each of the coils, the manufacturing method comprising:
a step of fixing to-be-machined coil ends by pressing the to-be-machined coil ends from an inner side toward an outer side in a radial direction of the stator core;
a step of fixing a relative position between the stator core and the to-be-machined coil ends in the axial direction of the stator core; and
a step of machining the to-be-machined coil ends fixed by pressing.
